(19) United States
(12) Patent Application Publication
(10) Pub. No.: US 2005/0267386 A1
(43) Pub. Date: Dec. 1, 2005

(54) Breast tissue expanding device

(76) Inventor: Rachel Copelan, West Hollywood, CA (US)

Correspondence Address: Rachel Copelan, 999 N. Doheny Drive, West Hollywood, CA, 90069, US

(21) Appl. No.: 10/853,923

(22) Filed: May 25, 2004

(51) Int. Cl. A61H 7/00

(52) U.S. Cl. 601/14; 601/11; 601/6

(57) ABSTRACT

A device for expanding the connective fatty tissue and correcting inverted nipples and improving symmetry of the human breast by the application of gentle suction generated by oral inhalation comprises a hollow dome constructed from a pliable but rigid polymer. A rim on the open end of the dome provides an air tight seal with the skin tissue surrounding the breast. Tubing connected to the top center of the hollow dome facilitates oral evacuation of the air surrounding the breast. A valve or clamp allows the applied vacuum to be maintained for a desired period and readily released when desired. Oral application of the vacuum prevents excessive vacuum or pressure from being applied to the breast or surrounding tissue.

### BACKGROUND OF THE INVENTION

1. Field of the Invention

The present invention generally relates to a biological tissue augmentation device and more specifically to a device for expanding the human breast and treating inverted nipples.

2. Description of Prior Art

The development of the female breast plays an important role in developing both positive self esteem for women and their ability to nurse offspring. Women have desired to enhance the size and shape of their breasts to look better in clothes and be more sexually desirable to men. Many women experience a secondary aesthetic breast problem, namely having one breast smaller than the other, resulting in aesthetic disparity between the two breasts. Another secondary aesthetic breast problem is stretch-marks caused by the breast being pulled by gravity over a period of time. In addition, the normal, protruding condition of the breast nipple is crucial to women wishing to breast-feed their babies.

The expansion of biological tissue in the female human breast is a well known problem in the medical device field. One medical approach to improve the breast appearance has been to surgically insert silicone implants into the breast region to increase size and fullness. This surgical procedure is an expensive medical operation, and is limited to women who need reconstructive breast surgery. The result of medical research indicates that these devices can negatively affect a women's long term health.

Another medical approach is known as hydrotherapy, employing pulsating jets of water impinging on the outside of the breast. This approach has had very limited success since the skin of the breast can be damaged by constant external pulsating jets of water. In addition, the internal connective breast tissue is not stimulated deep enough by this approach to create expansion within the breast tissue.

Still another approach to this problem has been mechanical suction devices that create a vacuum (or negative pressure) within a shape retaining cup. In theory, the vacuum in a retaining cup should result in breast tissue being drawn into the cup for a period of time to facilitate breast expansion. However, care must be taken to assure that an excessive negative pressure is not applied. It is well known to medical practitioners that the normal capillary pressure in skin tissue is about 32 mmHg. An external negative pressure (vacuum) applied to the breast in excess of 32 mmHg can expand the capillaries in the breast tissue causing them to leak or rupture, resulting in bruising and the formation of black and blue marks on the breast tissue and surrounding tissue on the chest wall. Also, if pressure is applied to a skin surface by the skin contact surface of the device, such as to the skin surrounding the breast being treated, and such force is in excess of about 32 mmHg, the capillaries feeding the skin tissue can be occluded and blood flow can be decreased or obstructed, causing the tissue to be deprived of oxygen. This can result in cell death and possibly the formation of decubitus ulcers. Prior art devices which attempted to create suction by utilizing various types of hand pumps, hydraulics, and electric motors, generally do not have the ability to adequately control or minimize the applied vacuum to avoid damage to the breast and surrounding tissue. In some instance, cushions or wide contact surfaces were provided in an attempt to spread out and minimize the level of pressure applied to a specific spot, so as to minimize the likelihood of bruising or more severely damaging the chest tissue. However, these attempts did nothing to control the level of vacuum surrounding the breast tissue caused by an excessive vacuum within the treatment device. These devices have also been found to be expensive and difficult to use due to moving parts that breakdown frequently and the weight of the devices which places a stress on the breast tissue during operation.

Also, in some prior art devices that claim to be portable, the evacuation of air is intermittent rather than a steadily maintained suction which is needed to create a controlled prolonged vacuum.

Thus, prior art devices have been ineffective due to their inability to create and maintain the proper level of suction. The design of most prior art devices could create a dangerous level of suction, resulting in stretching and bruising of the breast tissue. The devices described herein provide the user free movement due to its light weight and portability while it is performing the breast expansion treatment. This is an important factor to assure a noticeable change in the size and shape of the breast tissue.

Prior art devices also indicated that from around fifteen minutes to 8 hours per breast each day was necessary to affect, if any, change in the breast tissue region. However, as disclosed in Copelan U.S. Pat. No. 5,520,613, this can be accomplished in 5 minutes or less each day. This improvement, which represented a significant improvement over prior art, is the result of utilizing respiratory suction to apply a vacuum to the area over the breast. Intrapulmonary pressures on inhaling are from about 1 to about 3 mmHg with normal pressure being from about 1.0 to 1.5 mmHg. The inhalation developed negative pressure provides a vacuum in the dome surrounding the breast at a level far below that which could cause tissue damage while expanding the respiration capacity, which helps increase the lung capacity and develops the pectoral muscular platform.

The condition of the breast known as inverted nipples is a major hurdle faced by mothers in their attempt to effectively breast-feed their babies. This inability leads to frustration with both the mother and baby, forcing the infant to be fed from a bottle, limiting the emotion bond so important during nursing.

Treatments to expand inverted breast nipples have included the use of suction generated by breast shields, syringes and breast pumps. These devices have had limited success due to their weight, design and the user's inability to closely control the level of treatment, resulting in trauma to the surrounding breast tissue.

The present invention is an improvement over the prior Copelan device which utilizes respiratory suction along with a valve/timer to provide a constant vacuum to the breast tissue.

The prior Copelan device uses a low density, high strength, pliable polyethylene to form the hollow dome and surrounding lip. A breathing tube with mouthpiece and valve-timer is attached to the dome. The pliable material of the hollow dome allows it to be squeezed and contoured to adjust to the upper chest area surrounding the breast. The light weight design of both the prior Copelan device and the present invention makes it possible to conform the dome to the body's contour and remain sealed to the user's chest. Thus, the user's hands may be removed from the device, allowing freedom to apply make-up, brush hair or any other grooming activity while the device is performing its desired function. Mobility allows the user to maintain a regular exercise program at the same time which can help fill the internal fibro-connective fatty tissue of the breast to diminish and make unattractive stretch-marks become less noticeable.

The present invention improves the ability to create both specific and general suction over the breast at the vacuum level and for the time desired. Utilizing respiratory suction the level of vacuum is naturally limited to a safe level which eliminates the risk of bruising to the breast tissue by too great an applied vacuum or surrounding tissue on the chest wall by pressure from the rim on the cup.

The novel features of the present invention, both as to its design and method of operation, together with further objectives and advantages thereof, will be better understood from the following description considered in connection with the accompanying drawings in which a presently preferred embodiment of the invention is illustrated by way of example.

It is expressly understood, however, that the drawings are for the purpose of illustration and description only and are not intended as a definition of the limits of the present invention.

### BRIEF DESCRIPTION OF THE DRAWINGS

FIG. 1 is a perspective view of a respiratory breast tissue expanding device incorporating features of the invention.

FIG. 2 is a side view of the present invention showing the embodiment of FIG. 1, with the various components and parts disassembled.

FIG. 3 is a front perspective view of the present invention showing the tubing portion of the embodiment of FIG. 1, with the tubing clamp positioned thereon to allow the passage of air through the pliable breathing tube.

FIG. 4 is a front perspective view of the present invention showing the tubing portion of the embodiment of FIG. 1, with a closed tubing clamp mounted thereon to shut off the passage of air through the pliable breathing tube.

FIG. 5 illustrates the use of the present invention with the hollow dome being applied by the user to the left breast with oral suction being applied to the dome interior.

FIG. 6 illustrates the use of the present invention applied to the right breast with the valve in the closed position.

FIG. 7 is a cross sectional side view of an alternative air flow mechanism comprising an in-line duckbill valve installed in the tubing lumen.

FIG. 8 is a cross sectional side view of the embodiment of FIG. 7 rotated 180° round its central axis further including a vacuum control vent.

FIG. 9 is a cross sectional end view taken along line 9-9 of FIG. 7 with the duck bill valve in a closed position.

FIG. 10 is a cross sectional end view taken along line 9-9 of FIG. 7 with the duck bill valve in an open position.

FIG. 11 is a side view of an alternative design of a tubing clamp.

### DETAILED DESCRIPTION OF THE PRESENTLY PREFERRED EMBODIMENT

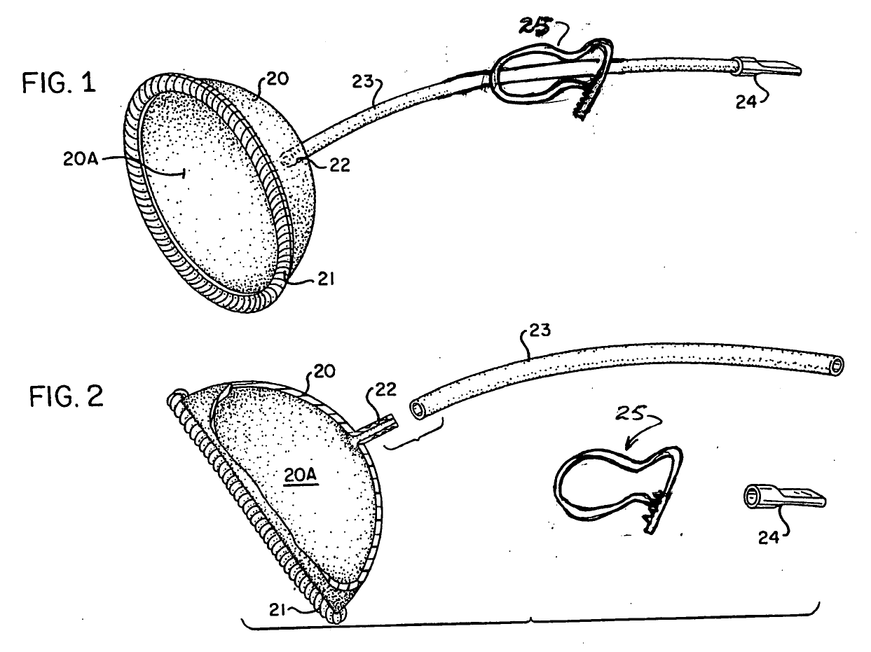

An understanding of the present invention can be best gained by reference to FIGS. 1 through 6. The present invention employs a hollow dome 20 which is to be placed over, and is spaced from, the breast tissue, making contact only with the surrounding skin on the chest wall of the user.

The hollow dome 20 is preferably hemispheric in profile, with a hollow interior 20a and a surrounding rim 21 which, in use, contacts the surface of the chest around the breast. The rim 21 may be textured in design and pliable to allow leak proof attachment to the chest when a vacuum is applied without making contact with the skin of the breast. It is also contemplated that a soft sealing material, such as a closed pore foam or other similarly functioning materials may be applied to the rim to aid in sealing. A tubing connector 22, located approximately at the top of the center of the hollow dome 20, has a pliable breathing tube 23 attached thereto. A tubing clamp 25 is mounted on the tube 23. The tubing clamp 25 is opened and then closed after reducing the atmospheric pressure in the interior 20a of the hollow dome 20 placed in position surrounding the contained breast. Opening the clamp 25 allows the pressure surrounding the breast to return to ambient pressure conditions and the removal of the dome 20. A removable mouthpiece 24 may be attached to the pliable breathing tube 23.

As stated hereinabove, one of the advantages of the present invention over those devices disclosed by prior art is the ability of the user to create a safe level of suction around the breast through use of oral respiration rather than by mechanical pumping elements such as manual (hand pump), electrical motor or hydraulic (water aspiration) system. The prior art devices present a high risk of developing a level of vacuum (negative pressure) over the breast or creating an excessive pressure against the skin surrounding the breast which may inadvertently cause injury. In contrast, the present invention, because it limits the negative pressure to that which can be applied by normal inhalation, is as gentle as the nursing of an infant. In addition, it produces healthy physiological responses in the user rather than the harsh effect associated with excessive negative vacuum which can be applied by hydraulic, electrical or other mechanical systems of prior art devices.

While shaped generally to conform the contour of the chest of a user, the materials used to form the dome 20 are soft and pliable to avoid the necessity of molding the hollow dome 20 to exactly match the user's body contour. Because the hollow dome 20 is pliable it will conform, as necessary to the curvature of the female chest. In addition, the materials used are solid enough to prevent the escape of air and loss of vacuum and to prevent collapse of the dome under normal operating levels of vacuum.

The surrounding rim 21 is preferably molded of the same material and is an integral part of hollow dome 20. The surrounding rim 21 may also be textured to assure a firm, yet gentle grip on the skin which surrounds the breast tissue. This provides for a complete air-tight seal, which is essential for success in a breast expansion device.

The hollow dome 20 is preferably made of a low density polyethylene. However, a broad range of thermoplastic, elastomeric or thermo-setting polymeric materials can be used to fabricate the dome 20 and integral rim 21, including, but not limited to polypropylene, polyethylene, vinyl, polyurethane or silicone or natural rubber. A typical device, including the pliable breathing tube 23, a removable mouthpiece 24, clamp 25 and/or valve weighs about 2 ounces, which is much less than prior art devices. As a result, the weight of the product will not cause the vacuum seal to the chest wall to be broken and the device will remain in place without the need to use straps or other attachment means.

The product is easy to disassembly for washing and reassembly. The nipple 22 on the hollow dome 20 readily receives the end of the pliable breathing tube 23. In the first embodiment shown the pliable breather tune 23 is passed through an insert opening 27 in the clamp 25. However one skilled in the art will recognize that there are numerous devices and techniques which can be used to apply external clamping pressure to the tube to restrict flow of air in or out of the tube once the vacuum is established. The mouthpiece 24 is attached to the other end of the tube. Alternatively the mouthpiece may be integral with the end of the tube or the device may be used without a separate or discrete mouthpiece, i.e. the user can suck on the tube itself. This modularity of parts allows the device to be disassembled, sanitized and reassembled and the ability to interchange mouthpieces allows various women within a family to use the same device to avoid the expense of an additional device.

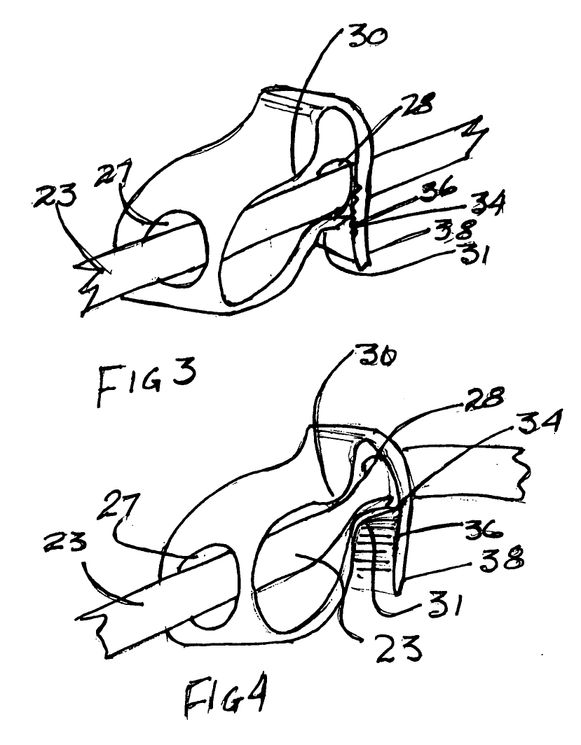

FIG. 3, is a front perspective view of the open position of a representative clamp 25 fabricated from rigid plastic. The clamp 25 has a first and second opening 27, 28 through which the pliable breathing tube 23 passes. The insert openings 27, 28 are round holes such that the tube 23 passing through both openings resides between the first and second crimping surfaces 30, 31. A lower end portion 32 has an end 34 which interacts with grooves or raised teeth 36 on an inner surface of the upper end portion 38 to hold the crimping surfaces in an open or closed relationship in regard to the tube positioned there between. FIG. 3 shows the clamp in its open position with the tube residing therein having an unobstructed flow path there through. FIG. 4 shows the same clamp in a closed position, with the tube 23 being pinched there between to obstruct air flow there through.

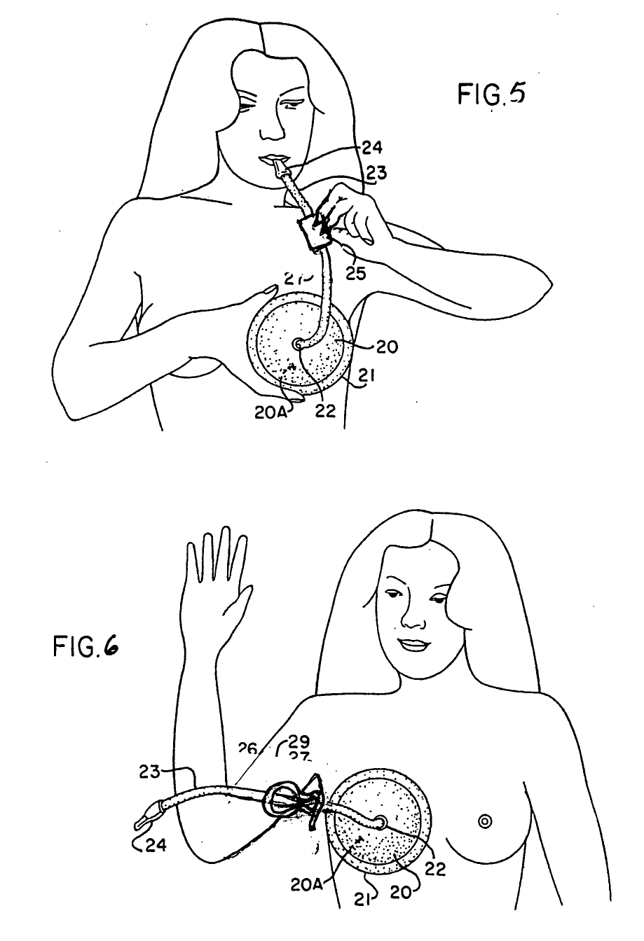

FIG. 5 shows an example of the use of the present invention described above. When the hollow dome 20 is squeezed and placed over a desired location on the user's breast, the surrounding rim 21 will conform to the skin surface around the breast and create a negative pressure within the dome. The user can additionally control the level of negative pressure by inhalation of air through the removable mouthpiece 24 connected to the pliable breathing tube 23 connected to the nipple 22 located in the center of the hollow dome 20. Once a vacuum is created in the cavity formed between the surface of the breast and the hollow interior of the dome 20 it is sustained by the user concurrently closing the clamp 25 to crimp the pliable breathing tube 23, closing off the flow of air through the pliable breathing tube 23. If the dome is also collapsible to some extent by squeezing, squeezing the resilient dome 20 prior to or during the vacuum application stage, will slightly decreases the internal volume of the dome and also provides a negative pressure or a slight additional negative pressure which results when the dome expands to its original configuration, due to its inherent resilience, upon removal of the squeezing action. When the dome includes a one-way valve, the negative pressure over the breast created by squeezing the dome is maintained until intentionally released.

Because the air pressure surrounding the breast tissue is now less then the internal fluid pressure within the breast, the breast tissue naturally fills with psychological fluids and expands. This is a result of the difference in pressures, the anatomical histological structure of the breasts, including the circulatory physiology and principles of tissue development, and an abundance of space in the breasts of a non-lactating and post-menstrual female. The breast also has suspensory ligaments, loose fibro-fatty connective tissue, glandular tissue and circulating fluid channels As an example, the vacuum pressure created by the device causes seepage of lymph fluid into these abundant interstitial spaces. This change is not necessarily permanent. While there is some residual effect, when the vacuum pressure is withdrawn, some of this fluid re-absorbs into the lymph channels.

However, the overall effect, particularly when the procedure is repeated over an extended period of time, is an enhancement of the breast size. Repeated fillings of the breast tissue in this manner causes expansion in size due to an increase in individual cell size as well as cell number much like muscle size is increased when exercised in the proper intensity and time duration. Such physical phenomena is known as “Adaptation Syndrome” which leads to the greatest, and in this instance desired, results when the user does not exceed the level of exercise that the body can quickly adapt to.

Suction generated by the device should initially be applied for about 30 seconds per breast on a daily basis. It should then be gradually increased by 30 second increments per day until a level of 5 minutes per breast is reached. If the user has a problem of asymmetrical breasts, the vacuum can be applies to the smaller breast for an extended time until the breast sizes are approximately the same. While a timer is not shown, any convenient timing device can be used.

Because of the design of the product and its ease of use, the user can readily control the time per breast, and vary that time to accomplish the desired results. This can be done without fear that excessive negative pressure is applied to the breast or excessive pressures will injure the tissue of the surrounding chest wall.

As shown in FIG. 6, once a vacuum has been created by sucking on the tube and the tube is clamped, the device will remain in place and the user can now free her hands from the hollow dome 20 and clamp 25 for the required length of time for that treatment period.

One skilled in the art will recognize that any number of alternative clamps can be used to pinch the tubing closed. FIG. 11 shows an example of an alternative clamp 50 with the tube 23 through the center thereof. This clamp 50 has a separate upper piece 52 and lower piece 54 which cooperate to crimp the tube 23 between the crimping surfaces 30, 31. To close the clamp 50 the user grasps the clamp 50 with the crimping points 30, 31 between two fingers and advances the lower piece 54 toward the upper piece 52. The lower piece 54 has ends 34 which interact with grooves or raised teeth 36 on opposed inner surfaces of the upper piece 52, thus crimping the tube and stopping air flow there through. To release the clamp 50 the two lower ends 56 of the upper piece 52 are pulled in opposite directions, releasing the ends 34 from the grooves 36.

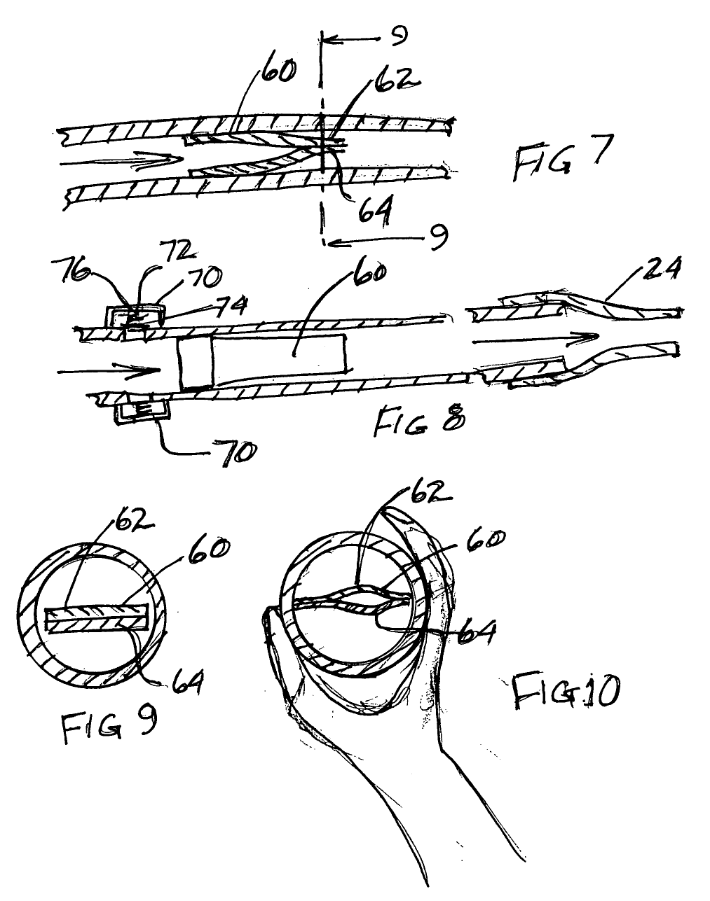

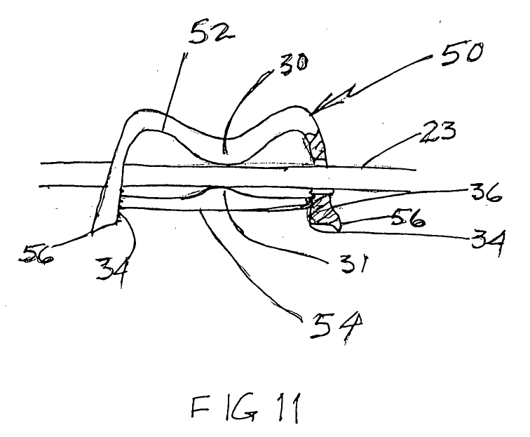

Alternatively, valves can be set within the tubing. FIGS. 7-10 show one example of a duck bill valve 60 located within the lumen of the tube 23. The valve 60 comprises a tube which transitions, at one end to two opposed flaps 62, 64. When a negative pressure, such as sucking, is applied to the mouth piece 24 air flows, in the direction of the arrows in FIGS. 7 and 8, through the duck bill valve, causing the opposed flaps 62, 64 to separate as shown in FIG. 11. When sucking is halted the flaps 62, 64 return to their normally closed position obstructing air flow in the opposite direction thus maintaining the negative pressure within the breast cup. The negative pressure can be released by pinching the tubing, and the sides of the duck bill valve 50 therein as also shown in FIG. 10. Again, this is merely illustrative of an alternative valve mechanism. One skilled in the art will recognize that many valves can be mounted on or in the tubing, or placed between two pieces of tubing to trap a negative pressure in the device once it is placed over the breast.

FIG. 8 includes a still further variation which may be added to any of the valve or clamp systems contemplated by the invention. Shown schematically is a pressure control vent 70 which in this instance comprises one or more flaps 72 held closed by an adjustable pressure spring 74. The spring/flap combination is chosen so that the flap 72 will uncover an opening 76 when a maximum negative pressure applied to the system is exceeded, and will occlude the opening 76 when the system is vented restoring the maximum intended negative pressure. This will prevent an individual who has a particularly strong respiratory system (such as an individual that does scuba diving) from applying to high a negative pressure when sucking on the mouthpiece. It will also prevent excessive pressure from being applied by an individual who does not follow the instructions and instead uses a mechanical device to apply the vacuum. Also, the vent may serve as a manual release valve to vent the system if so desired.

Thus, it is apparent that a new and non-obvious improved device for expanding breast tissue and nipples has been provided by the present invention which allows any user the opportunity to expand breast tissue more efficiently, conveniently and safely than does the prior art. While a preferred embodiment of the present invention has been described in detail, various modifications, alterations and changes may be made without departing from the spirit and scope of the present invention.

1. A breast tissue expanding device which utilizes orally generated negative pressure comprising;
a hollow lightweight hemispherical dome of pliable, solid construction, wherein the dome has an apex and a circumferential base, an inner surface beneath the dome, an outside surface on top of the dome, a rim extending around the circumferential base and a tubing connector with a passage through at the apex of the dome wherein
a pliable tube with a lumen there through, a first end of the tube connected to said tubing connector, a second end of the tube adapted for insertion into a user's mouth, the tubing having a length sufficient so that when the dome is placed over a user's breast the second end of the tubing can be placed in a user's mouth, and a flow restriction device mounted on the tubing or in the lumen of the tubing for selectively obstructing the lumen of the tube to prevent flow there through after application of a desired negative pressure.

2. The device of claim 1, wherein the rim is a formed of the same material as, and is integral with, the material used to form the dome, said rim having a surface which is textured to provide an airtight seal with the skin of a user beneath the dome upon the introduction of a vacuum applied by oral suction to the tube.

3. The device of claim 1, wherein the flow restriction device is a manually operated clamp mounted on the tubing.

4. The device of claim 1, wherein the flow restriction device is a valve mounted in the lumen of the tubing

5. The device of claim 1 further including a pressure release valve mounted on the tubing, said pressure release valve being adjustable to open if a preset negative pressure is exceeded.

6. The device of claim 1 wherein the resilient dome is also manually compressible so that upon application to a surrounding skin surface and release of manual compression the dome expands to create a negative pressure in an enclosed space under the dome.

7. A method of expanding breast tissue comprising by application of a controlled negative pressure to the breast of a user comprising;
providing a hollow lightweight hemispherical dome of a compressible, pliable, resilient construction, wherein the dome has an apex, a circumferential base, an inner volume beneath the dome, an outside surface on top of the dome, a rim extending around the base and a valve mounted at the apex of the dome wherein said valve operable to obstruct flow of air into the inner volume beneath the dome.
placing the dome over a breast with the rim in sealing contact with the chest wall of the user and compressing and releasing the dome resulting in a preset negative pressure being created within the space under the dome.
